(19) United States
(12) Patent Application Publication
(10) Pub. No.: US 2010/0011585 A1
(43) Pub. Date: Jan. 21, 2010

(54) Combination Shaving and Trimming Device

(76) Inventors: Michael Maichel, Frankfurt (DE); Markus Schuessler, Koenigstein (DE); Ralf Klug, Eschborn (DE); Cirilo Javier Perez Lopez, Eschborn (DE); Terence Gordon Royle, Hampshire (GB); Andreas Larscheid, Kelkheim (DE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/503,130

(22) Filed: Jul. 15, 2009

Related U.S. Application Data
(60) Provisional application No. 61/081,371, filed on Jul. 16, 2008.

(51) Int. Cl. B26B 21/40

(52) U.S. Cl. 30/34.1

(57) ABSTRACT

A combination shaving and trimming device includes a handle having an upper end and lower end, a powered trimmer disposed adjacent the upper end, a wet-shaving razor attachment comprising a connecting structure adapted for mounting over the trimmer onto the upper end, and a razor cartridge that mates with the connecting structure.

### CROSS REFERENCE TO RELATED APPLICATIONS

This application claims the benefit of U.S. Provisional Application No. 61/081,371, filed Jul. 16, 2008.

### FIELD OF THE INVENTION

The invention relates to a combination shaving and trimming device.

### BACKGROUND OF THE INVENTION

Most consumers find that dealing with multiple tools like a razor, scissors and an electric trimmer every time you want to change the look of your facial hair can be a real hassle.

There is a need to provide a device which overcomes this practice of inconveniently handling multiple implements and combines a shaving and trimming device.

### SUMMARY OF THE INVENTION

In an aspect, the invention features a combination shaving and trimming device that includes a handle, a powered trimmer, and a wet-shaving razor attachment. The handle has an upper end and lower end having the trimmer located at or near the upper end. The wet-shaving razor attachment includes a connecting structure and razor cartridge. The connecting structure is adapted for mounting over the trimmer onto the upper end. The razor cartridge engagably mates with the connecting structure.

In an aspect, the razor cartridge is removably attached to the connecting structure.

In another aspect, the wet-shaving razor attachment includes an ejection mechanism for removably attaching the razor cartridge from the connecting structure.

In another object, the razor cartridge includes one or more razor blades on a front surface and at least one blade disposed substantially perpendicular to the front surface.

In another aspect, the combination device is impervious to liquids.

In a further another aspect, a cap is removably attached at the lower end.

The combination device provides for a powered trimmer for an all-in-one device no longer need for a separate trimmer and razor.

Other features and advantages of the invention will be apparent from the description and drawings, and from the claims.

### BRIEF DESCRIPTION OF THE DRAWINGS

FIG. 1 is a perspective view of the combination shaving and trimming device; and

FIG. 2 is a perspective view of the separated shaving and trimming device.

### DETAILED DESCRIPTION OF THE INVENTION

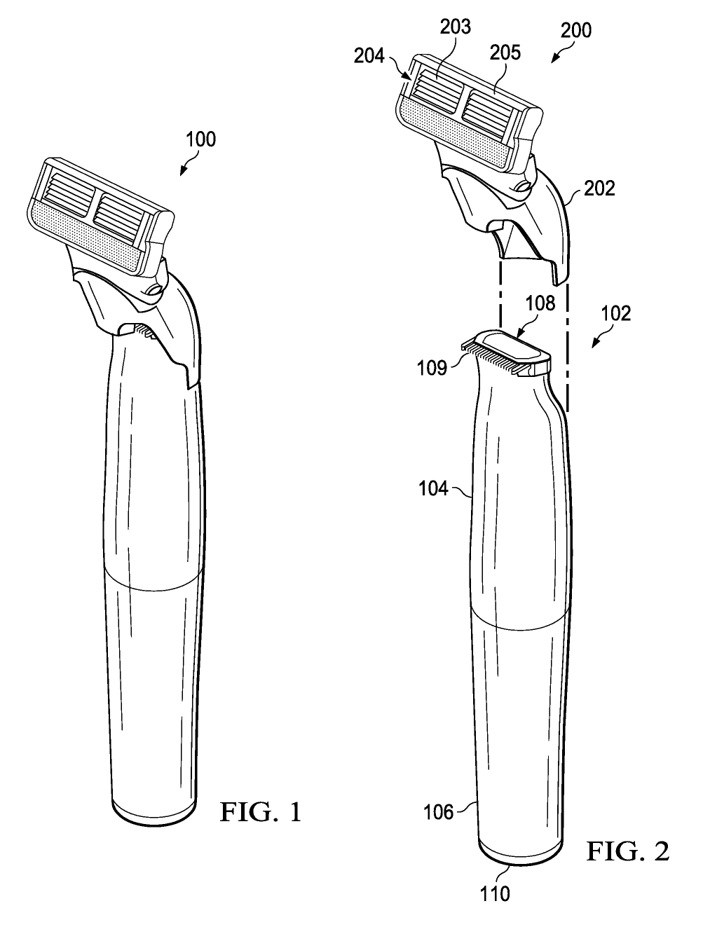

FIGS. 1 and 2 show a combination shaving and trimming device 100. The device 100 includes a handle 102, a powered trimmer 108, and a wet-shaving razor attachment 200. Device 100 is impervious to liquids. The handle 102 has an upper end 104 and lower end 106. Although in the depicted embodiment, upper and lower ends 104, 106 appear to be separable and formed independent of one another and joined thereafter, they may be integrally formed. In the present embodiment, a cap 110 is removably attached at the lower end 106. The cap 110, however, may also be integrally formed with the lower end 106. The trimmer 108 is located at or near upper end 104 and is configured for moving at least one trimming blade 109, which may be serrated, and wherein this trimming blade 109 which is disposed within the trimmer 108. In certain embodiments, there may be more than one trimming blade 109 where they are disposed in a stacked position and at least one reciprocates against the other to effect a trimming or cutting action on hair that is placed adjacent to a cutting edge of the one or more trimming blades 109.

The wet-shaving razor attachment 200 includes connecting structure 202 and razor cartridge 204. The connecting structure 202 is adapted for mounting over the trimmer 108 onto the upper end 104. The razor cartridge 204 engagably mates with the connecting structure 202. In the embodiment of FIG. 2, the razor cartridge 204 is removably attached with the connecting structure 202. The razor cartridge 204 includes one or more blade assemblies 203 that are mounted within a housing 205 of the cartridge. The device 100 is configured to operate as a trimming device, as shown in FIG. 2, or as a wet-shaving device, show in FIG. 1. In an embodiment, the combination shaving and trimming device can function as a powered wet-shaving device by actuating trimmer 108 such that the resulting vibration from moving the at least one trimming blade translates vibration to the razor attachment 200.

In another embodiment (not shown), the wet-shaving razor attachment 200 includes an ejection mechanism for removably attaching the razor cartridge 204 from the connecting structure 202. In yet another embodiment, the razor cartridge 204 includes one or more razor blades on a front surface and at least one blade disposed substantially perpendicular to the front surface. The razor cartridge 204 can be of the type disclosed in U.S. patent application Ser. No. 10/799,946 to Vincent Walker and assigned to The Gillette Company, which are hereby incorporated by reference.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A combination shaving and trimming device comprising:
a handle having an upper end and lower end;
a powered trimmer disposed adjacent the upper end; and
a wet-shaving razor attachment comprising:
a connecting structure adapted for mounting over the trimmer onto the upper end; and
a razor cartridge that mates with the connecting structure.

2. The device of claim 1 wherein the lower end comprises a removably attached cap.

3. The device of claim 1 wherein the razor cartridge is removably attached to the connecting structure.

4. The device of claim 1 wherein the wet-shaving razor attachment further comprises an ejection mechanism for removably attaching the razor cartridge from the connecting structure.

5. The device of claim 1 wherein the device is impervious to liquids.

6. The device of claim 1 wherein the razor cartridge further comprises one or more blade assemblies disposed within a housing of the razor cartridge.

7. The device of claim 1 wherein the cartridge comprises two or more trimming blades disposed in a stacked position wherein at least one trimming blade reciprocates against another.

8. The device of claim 1 wherein the upper end and the lower ends are integrally formed.
